(19) United States
(12) Patent Application Publication
(10) Pub. No.: US 2006/0010485 A1
(43) Pub. Date: Jan. 12, 2006

(54) Network security method

(76) Inventor: Jim Gorman, (US)

Correspondence Address: ROBERT A. PARSONS, 4000 N. CENTRAL AVENUE, SUITE 1220, PHOENIX, AZ, 85012, US

(21) Appl. No.: 11/177,582

(22) Filed: Jul. 8, 2005

Related U.S. Application Data
(60) Provisional application No. 60/586,988, filed on Jul. 12, 2004.

(51) Int. Cl. G06F 15/16

(52) U.S. Cl. 726/3

(57) ABSTRACT

A method includes detecting software installed on a first computer; checking the software to see if it is security compliant; preventing the first computer from communicating with a second computer if the software is security non-compliant; and allowing the first computer to communicate with a third computer, the third computer making the first computer security compliant.

### CROSS-REFERENCE TO RELATED APPLICATIONS

This application claims the benefit of U.S. Provisional Application No. 60/586,988, filed 12 Jul. 2004.

### BACKGROUND OF THE INVENTION

1. Field of the Invention

This invention relates generally to computers and, more particularly, to providing security to a network of computers.

2. Related Art and Prior Art Statement

According to a recent survey conducted by the Computer Security Institute of San Francisco and the Federal Bureau of Investigation (FBI), 85% of the 538 respondents reported security breaches and 26% reported the theft of intellectual property. This represented a 20% increase from prior years. The survey also revealed that the cost of these security breaches is increasing with more respondents documenting the damage done by the theft of intellectual property.

Security breaches can come in many different forms, such as computer viruses. Computer viruses are software programs designed to interfere with computer operation. They can also record, corrupt, or delete data, or spread themselves to other computers and throughout the Internet. Typical attacks include a Denial of Service (DOS) attack or unauthorized use of the computing system. These attacks can cause financial loss, loss or endangerment of life, loss of trust in a computer network, and loss of public confidence.

While viruses typically require computer users to inadvertently share or send them, there are some viruses that are more sophisticated, such as worms, which can replicate and send themselves automatically to other computers by controlling other software programs, such as an e-mail sharing application. Certain viruses, called Trojans (named after the fabled Trojan horse), can falsely appear as a beneficial program to coax users into downloading them. The Trojan typically records personal information about the user while running in the background.

Although it's good to be aware of these different types of viruses and how they work, it is also important to keep a computer current with the latest updates and antivirus tools, stay current about recent virus threats, and follow a few basic rules when surfing the Internet, downloading files, and opening attachments. Once a virus is on your computer, its type or the method it used to get there is not as critical as removing it and preventing further infection.

As network security attacks have moved beyond corporate firewalls and websites, the focus has shifted to a more vulnerable set of targets-network end-points. Even though computers and servers may be sitting behind enterprise-hardened Demilitarized Zones (DMZs), virtual private networks (VPNs), and firewalls, they can be vulnerable because of the data they handle (emails, IM, file transfers, etc.) or the unsecured networks they communicate with (cable, wireless, DSL, AOL, MSN, etc.).

Since damage from computer viruses can be substantial, business enterprises are considering ways to prevent or reduce known vulnerabilities. An enterprise is generally a business organization, such as a corporation or business, which utilizes computers in a network. The network can be an intranet or local area network, for example, which is connected with other networks and/or the Internet. Business enterprises are rapidly adopting business models that require expanded network connectivity to other corporation locations, business partners as well as to the Internet based customers. They are also typically expanding their network connectivity at multiple locations, integrating extranets, and working with mobile users or visitors. Businesses have an ever-greater need to connect their remote locations, telecommuters and road warriors to their “corporate” networks across public networks on a 24×7 basis. They are finding it increasingly complex and expensive to deploy a myriad of point security products at these locations, keeping them updated and managing them in an effective way to ensure “real” security. Hence, a solution is needed to provide a better policy-based solution for enterprises to automate end-point preparation before granting access to network resources. Accordingly, there is a need for more protection of computer networks against security breaches.

### BRIEF SUMMARY OF THE INVENTION

The present invention provides a method which includes detecting software installed on a first computer; checking the software to see if it is security compliant; preventing the first computer from communicating with a second computer if the software is security non-compliant; and allowing the first computer to communicate with a third computer, the third computer making the first computer security compliant.

The present invention also provides a method which includes providing a first computer which runs software; detecting with a second computer the software running on the first computer to see if it needs to be updated; allowing the first computer to communicate with a third computer if the software has been updated; preventing the first computer from communicating with the third computer if the software has not been updated; and updating the software on the first computer if it needs to be updated so that the first computer is security compliant.

The present invention further provides a method which includes detecting software installed on a plurality of computers; checking the software installed on each computer to see if it is up to date; allowing each computer in the plurality of computers to connect to a first communication network if its software is up to date; allowing each computer in the plurality of computers to connect to a second communication network if its software is not up to date; and updating the software installed on each computer if it is not up to date.

These and other features, aspects, and advantages of the present invention will become better understood with reference to the following drawings, description, and claims.

### BRIEF DESCRIPTION OF THE DRAWINGS

Referring to the drawings:

FIG. 1 is a simplified perspective view of a communication network in accordance with the present invention;

FIG. 2 is a simplified perspective view of another communication network in accordance with the present invention;

FIG. 3 is a simplified flow diagram of a method of protecting a communication network in accordance with the present invention;

FIG. 4 is a simplified flow diagram of another method of protecting a communication network in accordance with the present invention; and

FIG. 5 is a simplified flow diagram of a method of protecting a communication network in accordance with the present invention.

### DETAILED DESCRIPTION OF THE INVENTION

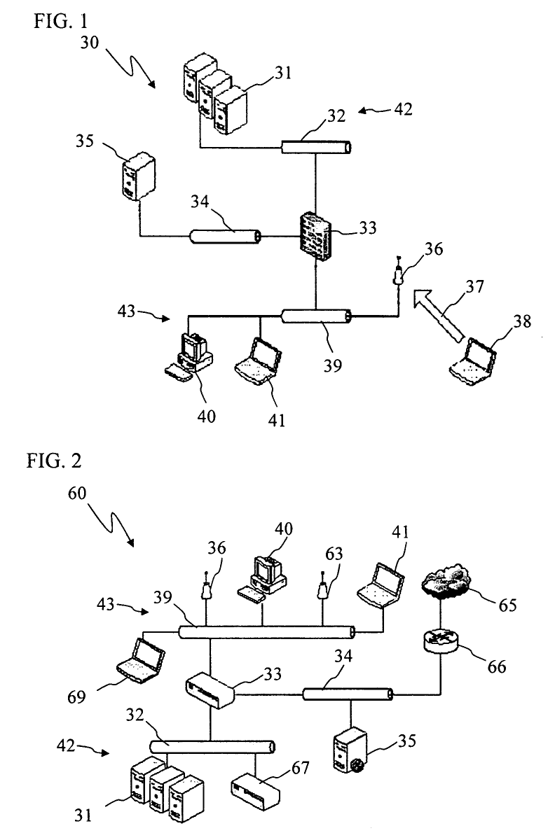

FIG. 1 is a simplified schematic of a communication network 30 in accordance with the present invention. It should be noted that like reference characters indicate corresponding elements throughout the several views. A communication network is typically a system of computers or other electronic devices interconnected together so that they can communicate and share information. Network 30 has several advantages which make it useful over previous networks. For example, network 30 provides better security because it does not allow certain computers in one network to connect to a different network or other computers if these computers do not meet the requirements of a predetermined level of security. Those computers that do meet the requirements of the predetermined level of security are said to be security compliant and those that don't are said to be non-compliant. The computers that are compliant are allowed to connect to other compliant computers in the network and those that are non-compliant are not allowed to connect to other computers in the network until they are compliant. In this way, non-compliant computers are isolated or quarantined. This reduces the likelihood that these non-compliant computers will be negatively affected by unauthorized users and/or malicious software, such as viruses, worms, etc. and if they are infected, it reduces the likelihood that they will infect other computers and cause damage.

Another advantage of network 30 is that it allows the non-compliant computers to connect to a security server so they can be made compliant. A server is generally a computer that provides some service for other computers connected to it via a network. The security server runs security software which can make the non-compliant computers compliant. First, the security software checks to see if the computer has a software agent installed on it. The software agent allows the security software to determine if the computer has the predetermined level of security. If the computer does not have the software agent installed or does not allow it to be installed, then it is isolated or quarantined until the software agent is installed.

After the software agent is installed, the security software determines if the computer has the predetermined level of security. If the computer does not, then the security software updates it. This allows the software to be updated faster and more regularly because the software update is done automatically instead of manually. Since the software is updated faster and more regularly, network 30 provides a more uniform amount of security from one computer to another. This is useful because unauthorized users and/or malicious software often attack computers with weak security and avoid computers with strong security. Since the computers that are not updated are isolated or quarantined until they are brought into security policy compliance, this threat is reduced.

The security software provides stronger security because it provides better patch management, configuration management, and intrusion prevention, as will be discussed in more detail below. In this embodiment, the patch management is provided by patch management software, the configuration management is provided by configuration management software, and the intrusion prevention is provided by intrusion prevention software. Intrusion prevention reduces the likelihood of spyware being undesirably installed on a computer in the network.

In one embodiment, network 30 includes an internal network 42 in communication with an external network 43 through an access manager 33. Internal network 42 includes internal servers 31 connected to access manager 33 through an internal local area network (LAN) 32. External network 43 includes wired desktop and laptop computers 40 and 41, respectively, which are connected to access manager 33 through an external LAN 39. A wireless laptop computer 38 is connected to access manager 33 through a wireless link 37 which is in communication with external LAN 39 through a wireless access point 36. In this embodiment, network 30 also includes a security server 35 connected to access manager 33 through a security LAN 34. It should be noted that before a computer is determined to be security compliant or non-compliant and when the computer is quarantined or isolated, it is allowed to send and receive Dynamic Host Configuration Protocol (DHCP) packets. It is also allowed to send and receive hypertext transfer protocol (HTTP) and hypertext transfer protocol secure (HTTPS) packets from security server 35 and access manager 33.

In operation, it is generally desired for there to be communication between internal network 42 and external network 43. However, it is also desired that this communication be done only if the computers included in internal network 42 and external network 43 have up to date software so that the likelihood of them being infected or attacked is decreased. For example, when internal server 31 attempts to communicate with LAN 39, it first attempts to logon to access manager 33. In response, access manager 33 communicates with security server 35 and the security software determines if server 31 has a software agent installed. If server 31 does not have the software agent installed, then it is installed by the security software if server 31 allows it. If server 31 does not allow it, then server 31 is quarantined from internal LAN 32 by the security software. After the software agent is installed on server 31, access manager 33 communicates with security server 35 and the security software determines if server 31 has updated software. If server 31 does have updated software, then it is allowed by the security software to access external network 43. If server 31 does not have updated software, then the security software prevents server 31 from communicating with outside network 43 and installs updated software on it if server 31 allows it. If server 31 does not allow it, then server 31 is quarantined by the security software so it cannot communicate with internal LAN 32.

In another example, when computer 41 attempts to communicate with internal LAN 32, it first attempts to logon to access manager 33. In response, access manager 33 communicates with security server 35 and the security software determines if computer 41 has a software agent installed. If computer 41 does not have the software agent installed, it is installed by the security software if computer 41 allows it. If computer 41 does not allow it, then computer 41 is not allowed by the security software to connect to LAN 32. After the software agent is installed on computer 41, access manager 33 communicates with security server 35 and the security software determines if computer 41 has updated software. If computer 41 does have updated software, then it is allowed by the security software to access internal LAN 32. If computer 41 does not have updated software, then the security software prevents network 43 from communicating with internal LAN 32. The security software then prompts computer 41 to install updated software on it. If computer 41 does not allow the updated software to be installed, then it is not allowed by the security software to connect to LAN 32. After the updated software is installed, computer 41 is allowed by the security software to communicate with LAN 32.

In this embodiment, the security software includes a patch management software component, a configuration management software component, and an intrusion management software component. It should be noted, however, that in other embodiments, the security software can include fewer or more components. It should also be noted that the security software can be written in many different programming languages, such as C, C++, etc. and that server 35 can run many different types of operating systems, such as a Microsoft Windows or MacIntosh based operating system, Novell NetWare, UNIX, or LINUX. It should further be noted that server 35 can communicate with other computers that run different operating systems then it is. For example, server 35 can run Windows XP and the computer it is communicating with, such as computer 41, can be running UNIX or LINUX.

In this embodiment, the patch management software includes several components. Here, it includes update software, remediation software, scanner software, and anti-spyware software to provide improved protection for network 30. It should be noted, however, that in other embodiments, the patch management software can include fewer or more of these components. The patch management software is implemented on network 30 and not just on servers 31 so that the users on network 30 know what patches and security updates reside on other computers that can connect to theirs.

The update software is a secure, proactive, and preventative program that scans network 30 for security problems and fixes them. It does this by first checking to see if each computer in network 30 has a software agent installed on it. If a computer doesn't, then the patch management software installs the agent. If a computer does not let the agent be installed, then the security software does not allow that computer to communicate with other computers in network 30. This increases the likelihood that the computers in network 30 are all protected and that computers without the agent are isolated or quarantined. Remote computers that try to connect to network 30 are also prompted to install the agent if they don't already have it. Hence, even computers that belong to remote users on laptops and workstations are protected or they are not allowed to connect to network 30.

There are several advantages to the update software. One advantage is that it is scalable so it can be used on networks of various sizes. Scalability meets large-scale, complex network security requirements as well as small-to mid-size business patch management needs. The update software is extremely scalable with full support for redundant and high-availability topologies including clustering, auto failover, and load-balancing. Further, the update software has an optimized database to accommodate more nodes per server, which reduces the total cost of ownership.

Another advantage is that the update software can monitor and maintain patch compliance throughout network 30. The update software works interactively between the server and client to accurately detect security vulnerabilities and provide a faster and more intuitive method for correcting them across network 30. This intelligent technology compiles a digital inventory profile by performing a comprehensive scan of the software, hardware, and drivers included in network 30. Based on this profile, the update software reports and archives the versions and dates of existing patches, as well as any missing patches.

The remediation software is another component included in the patch management software. The remediation software is a fast and effective patch and configuration automation solution which facilitates efficient planning and execution of remediation activities. In this embodiment, the remediation software queries computers in network 30 to determine which assets require security fixes, such as a vendor patch or configuration changes. In one example, security administrators can then install patches that have been tested in advance, targeting only the computers that need them. It should be noted that not all vulnerabilities have a vendor patch associated with them. For example, misconfigured devices can create vulnerabilities such as opening non-approved ports or unknowingly hosting spyware applications. The remediation software addresses this security risk by enabling enterprises to catalogue and maintain configuration standards across their networks. Registry and user settings can also be deployed enterprise-wide to increase the uniform implementation of network standards.

There are several advantages provided by the remediation software. One advantage is that the remediation software supports patches for AIX, HP-UX, Linux and Microsoft operating systems, although it can also support patches for other operating systems. Additionally, the remediation software supports Microsoft application patches for Exchange, IIS and SQL Server, which increases the likelihood that vulnerabilities in these widely used applications are patched quickly and effectively. Another advantage of the remediation software is that it reduces the burden of manually patching a large number of computers and keeping them up-to-date. Enterprises that perform regular vulnerability assessments are frequently faced with the daunting task of remediating hundreds, if not thousands, of computers on their networks. Hence, the remediation software decreases the time and money it takes to manually update them.

The remediation software provides a patch management and device authentication capability that can intervene faster and preempt and/or avert the attack or at least decrease the amount of damage it does to network 30. The traditional approach is to manually intervene each time there is an attack to update the computers. This usually takes place after the attack has caused severe damage. With the alarming trend of new exploits, such as worms, being released just days after vulnerability patches have been issued for old exploits, the time to remediate vulnerabilities on network 30 is rapidly decreasing. Faced with the costly option of manually patching network 30, enterprises can now implement a scalable, automated solution using the remediation software to cost-effectively address this challenge.

The scan software allows the quick and efficient management of a large number of vulnerabilities in network 30. These vulnerabilities typically occur in different levels of network 30, such as within the operating systems, applications, and even network devices, such as routers and switches. The scan software scans the computers included in network 30 to detect these vulnerabilities. After scanning, the scan software delivers a report to security server 35 that details the found vulnerabilities and recommends the appropriate corrective actions and fixes. This feature allows security administrators to identify and prioritize network devices, providing a clear picture of the infrastructure of network 30, including servers, databases, switches, routers, and wireless access points.

One advantage of the scan software is that it scans using non-intrusive techniques that typically do not test by exploitation during normal scanning operations. As a result, the scan software scans the network without overloading its resources and without causing systems to crash. This makes the scan software especially powerful for remote scanning services. Another advantage is that it is also used to detect unauthorized wireless access points that may have been established to network 30. The scan software's wireless detection capabilities reduces the need for using handheld/wireless access detection tools and walking around network 30 to try to locate unauthorized wireless connections.

In addition to a comprehensive database of security audits, the scan software provides the ability to create new audits to check for security vulnerabilities in custom applications or other configurations that may be unique to network 30. This allows better enforcement of security policies and simplifies the process of building custom checks and getting them integrated into the scanning software for use in the next scan.

The scanning software is faster than others currently available. In fact, the scanning software is able to scan an entire Class C network in about 15 minutes. It also has the ability to scan the computers included in network 30, all types of operating systems, networked devices, and third-party or custom applications. The scanning software also includes a data base of threats which can be updated so that it is comprehensive and up-to-date. With this feature, vulnerability updates can be automatically downloaded at the beginning of every scanning session.

The patch management software also includes anti-spyware software. There are many different types of anti-spyware software that can be used, but in this embodiment the anti-spyware software includes Pest Patrol. Pest Patrol is a powerful security and personal privacy tool that detects and eliminates destructive software like Trojans, spyware, adware and hacker tools. It complements anti-virus and firewall software, extending protection against non-viral malicious software that can evade existing security software and personal privacy. This destructive software often runs in the background on a computer until something or someone sets it off. When that happens, passwords, personal data, and credit card numbers can be lost and/or stolen. If the computer is used to telecommute and connect to network 30 via a virtual private network (VPN), then this can lead to the unauthorized use of network 30.

Pest Patrol defeats spyware threats by detecting and removing Spyware and Adware that “phones home” information about the user, the user's computer, and the user's surfing habits. Pest Patrol also removes other spyware threats, such as remote access Trojans, denial-of-service attack agents, and probe tools. Remote Access Trojans (RATs) allow an attacker to remotely control your computer. Denial-of-Service (DoS) attack agents can crash or hang a program, or the entire network. Probe Tools look for vulnerabilities on the network that an unauthorized user can exploit.

The configuration management software validates that network 30 is free of configuration issues that could reveal unwanted vulnerabilities. The configuration management software can function in the same or a similar manner as the Patch Management software described above. One difference, however, is that instead of validating patch levels, the configuration management software utilizes the scanner software to find configuration-based vulnerabilities prior to allowing network access. This can be accomplished by defining a core set of audit criteria for the scanner software to scan for as the computer begins the authentication process. The core set of audit configurations can be defined by the potential client and/or specific fixes. Generally registry or configuration changes can be automated via ActiveX Controls, which currently exist in the scanner software.

The intrusion management software reduces the likelihood of spyware being undesirably installed on a computer in network 30. This can happen because a user may still choose to knowingly or unknowingly, connect to a system external to network 30 that installs spyware, Trojan software, or some other destructive malware component that can allow an unauthorized user to gain access to network 30. The intrusion management software has the capability of validating that such protection exists on a computer prior to granting its access to network 30. The intrusion management software functions in a manner similar to the Patch Management process described above. However, instead of validating patch levels, it validates the existence of a host-base Intrusion Prevention System (IDS) and Spyware prevention system. This is accomplished by checking for these services running on the computer prior to granting access to network 30.

FIG. 2 is a simplified schematic of a communication network 60 in accordance with the present invention. In one embodiment, network 60 includes internal servers 31 connected to access manager 33 through internal local area network (LAN) 32. A control server 67 is also connected to access manager 33 through internal LAN 32. In this embodiment, network 60 also includes security server 35 connected to access manager 33 through security LAN 34. Wired desktop and laptop computers 41 and 40 are connected to access manager 33 through external LAN 39. Authorized and unauthorized wireless access points 36 and 63, respectively, are connected to external LAN 39. Security LAN 34 is connected to the Internet 65 through an internet gateway 66. The operation of system 60 is similar to that of system 30 discussed above where the computers in system 60 are not allowed to communicate with other computers unless they are security compliant.

In this embodiment, access manager 33 includes a wireless gateway Vernier access manager and control server 67 includes a Vernier Control Server. It should be noted, however, that other gateways and control servers can be included in network 60, such as Blue Socket, but one is shown here for simplicity and ease of discussion. In this particular embodiment, access manager 33 includes a Vernier System 6500. This system is an enterprise-class WLAN Gateway solution that secures traffic at the wireless or LAN edge, supports advanced services for stationary or mobile users, and provides administrators with unprecedented visibility into and control over their networks. The Vernier gateway, which sits between the wireless LAN access point and a wiring closet switch, communicates with authentication servers and other Vernier appliances elsewhere in the network, even on separate subnets. This allows the same access control policies used on the wired network, and lets users stay authenticated when roaming from one subnet to another.

The System 6500 includes two types of network devices: a CS 6500 Control Server, which is installed at the network core, and one or more AM 6500 Access Managers, which are installed at the network edge. The Vernier CS 6500 Control Server is a 2U rack-mountable device that runs the Vernier Management Console, integrates with existing authentication systems, and serves as a central repository for access rights and logging information. Each Control Server supports up to 100 Vernier Access Managers and up to 20,000 users. Redundant Control Servers can be configured to provide stateful failover, ensuring that the failure of a single device never jeopardizes network security and management.

Access manager 33 performs packet-filtering and policy enforcement for a collection of access points. By monitoring and managing access point traffic, access managers 33 establish a secure gateway between wireless users and the wired network and prevent malicious traffic, including viruses and worms, from reaching network 60. At the same time, access manager 33 provides advanced enterprise-class WLAN services for end users. For example, access manager 33 automatically detects a user's movement from one wireless coverage zone to another and can automatically tunnel the user's network sessions to the new zone in order to provide uninterrupted network service. Access manager 33 can also function as a VPN endpoint, supporting industry standard encryption technologies for securing WLAN traffic.

As mentioned above, a Bluesocket Wireless Gateway can be used in place of the Vernier 6500 system. A Bluesocket Wireless Gateway offers single scalable solutions to the security, class of service (CoS), and management issues facing institutions, enterprises and service providers that deploy wireless LANs based on the IEEE 802.11 and Bluetooth standards. Bluesocket's product of Wireless Gateways reduce the total cost of ownership (TCO) of wireless LANs while maximizing their benefits—from small businesses and departments, to warehouses, hospitals, universities and large enterprises.

Bluesocket offers a range of scalable Wireless Gateways (WGs) to support enterprise WLAN deployments from the network edge to the core. The WG-1100 SOE (Small Office Edition) supports small offices and workgroups of 15 concurrent users; while the WG-1100 can support entire office floors of up to 100 users (at 30 Mbps encrypted/100 Mbps unencrypted); for medium to large enterprises, the WG-2100 offers hardware-based encryption acceleration, delivering encrypted-data performance up to 150 Mbps, and up to 400 Mbps for clear, unencrypted traffic. For larger enterprises requiring higher throughput and centralized WLAN management and control, the WG-5000 provides a core infrastructure platform supporting up to 1000 users with 2 Gigabit copper or fiber ports, delivering industry leading 400 Mbps performance for IPSec traffic, and 1 Gbps for clear traffic.

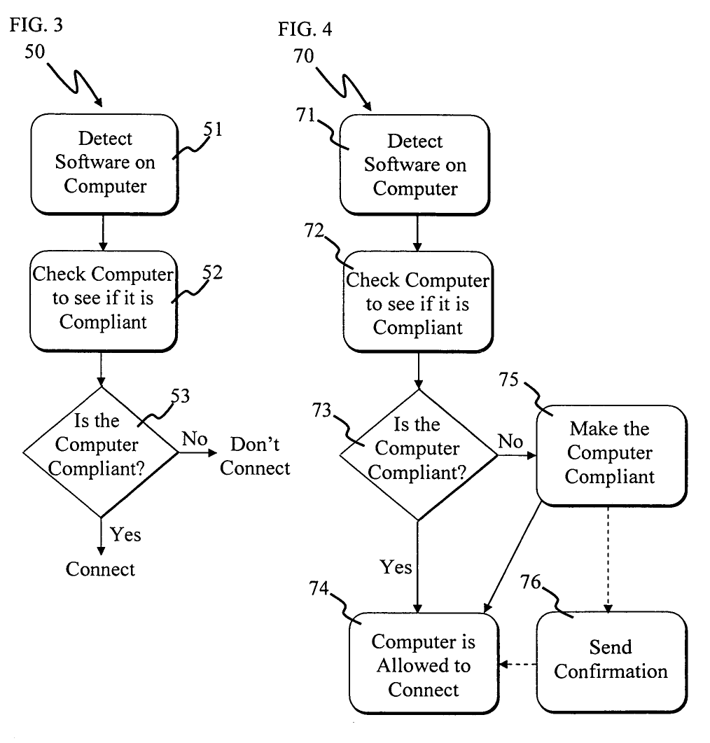

FIG. 3 is a simplified flow diagram of a method 50 of protecting a communication network in accordance with the present invention. It should be noted that the steps in method 50 can be performed in many other different orders than that shown here. Method 50 includes detecting software installed on a computer in a step 51. In a step 52, the computer is checked to see if it is security compliant. The computer is compliant if it has a software agent installed and if its software provides a predetermined level of security. In a step 53, the computer is prevented from communicating with another computer if it is security non-compliant and allowed to communicate with the other computer if it is security compliant. In accordance with the invention, the software is detected and checked by security software running on a security server. The security software also prevents the computer from communicating with the other computer if it is security non-compliant and allows the computer to communicate with the other computer if it is security compliant.

FIG. 4 is a simplified flow diagram of a method 70 of protecting a communication network in accordance with the present invention. It should be noted that the steps in method 70 can be performed in many other different orders than that shown here. Method 70 includes detecting software installed on a computer in a step 71. In a step 72, the computer is checked to see if it is security compliant. In a step 73, the computer is prevented from communicating with another computer if it is security non-compliant and allowed to communicate with the other computer if it is security compliant. If the computer is compliant, then it is allowed to connect to the network in a step 74. If the computer is non-compliant, then it is made compliant in a step 75. This can be done in response to one or more inputs. The input can include the click of a mouse button or the pressing of a key on a keyboard. From step 75, control can be passed to step 74 in some examples. In other examples, control can be sent to a step 76 where a confirmation that the software has been updated is sent. Control is then sent to step 74 where the computer is allowed to connect to the network.

In accordance with the invention, the software is detected, checked, and/or updated by security software running on a security server. The software can be updated in response to one or more inputs being received by the security server. The input can come from the computer to be made compliant or from an input device, such as a mouse or keyboard, connected to the security server. The security software also prevents the computer from communicating with the other computer if it is security non-compliant and allows the computer to communicate with the other computer if it is security compliant. In step 72, the computer is allowed to send and receive Dynamic Host Configuration Protocol (DHCP) packets. It is also allowed to send and receive hypertext transfer protocol (HTTP) and hypertext transfer protocol secure (HTTPS) packets from the security server and an access manager. Further, the confirmation sent in step 76 is sent between the computer and the security server.

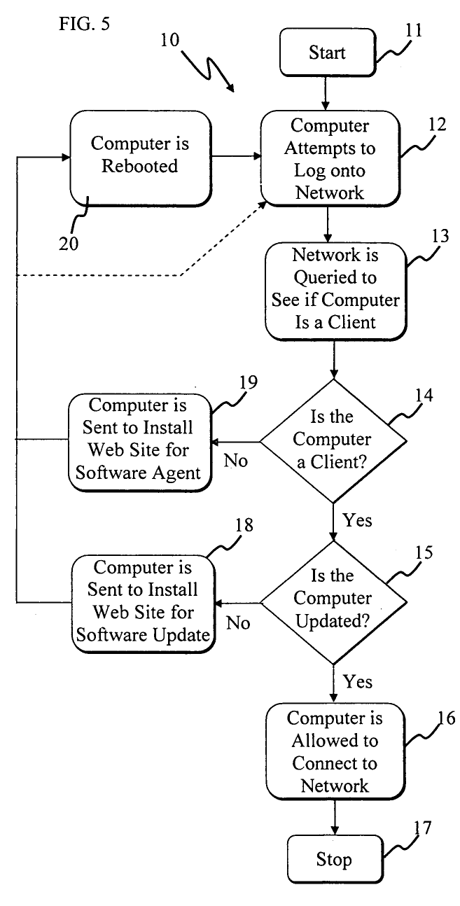

FIG. 5 is a simplified flow diagram of a method 10 of protecting a communication network in accordance with the present invention. It should be noted that the steps in method 10 can be performed in many other different orders than that shown here. Method 10 starts at step 11 and then a computer attempts to log onto the network in a step 12. In step 12, the computer is allowed to send and receive Dynamic Host Configuration Protocol (DHCP) packets. It is also allowed to send and receive hypertext transfer protocol (HTTP) and hypertext transfer protocol secure (HTTPS) packets from a security server and access manager. In a step 13, the network is queried to see if the computer is a client. If the computer is not a client, then in a step 14, the computer is sent to an install web site so that it can become a client by installing a software agent. The installation of the software agent is in response to one or more inputs being received by the web site. For example, the input can include clicking a mouse button when a cursor is positioned over a predefined area of the website. In an example, the input is communicated to the website by the computer or the security server. After the software agent is installed, the computer is rebooted in a step 20 and control goes back to step 12 where the computer attempts to logon to the network again. In some examples, the computer may not need to be rebooted, in which case control can go from step 19 to step 12 without step 20, as indicated by the dotted line and arrow.

If the computer is a client in step 14, then control is sent to a step 15 where it is determined whether the computer has updated software. If the computer does not have updated software, then control is sent to a step 18 where the computer is prompted to update its software by the install web site. In step 18, the security software and/or operating system software can be updated to make the computer security compliant. In some examples, the step of updating the software can include installing a software patch or a software program on the computer. In some examples, the software is updated in response to a single input. The input can be the click of a mouse or the pressing of a key on a keyboard, among others. After the software is updated, control is sent to step 20 where the computer is rebooted. In some examples, the computer may not need to be rebooted, in which case control can go from step 18 to step 12 without step 20, as indicated by the dotted line and arrow.

In some embodiments, a step of sending a confirmation between the computer and the security server after the software has been updated can be performed, but this is not shown here for simplicity. From step 20, control is sent to step 12 where the computer tries to logon to the network again. If the computer does have updated software in step 15, then control is sent to step 16 where the computer is allowed to connect to the network. Method 10 then ends with a step 17.

Various modifications and changes to the embodiments herein chosen for purposes of illustration will readily occur to those skilled in the art. For example, form 110 and/or the box lintel can be fabricated in a variety of ways while still performing the stated functions. Further, a variety of different masonry materials may be utilized and the walls may be fabricated in a variety of somewhat modified and/or interchanged steps.

The foregoing is given by way of example only. Other modifications and variations may be made by those skilled in the art without departing from the scope of the invention as defined by the following claims.

Having fully described and disclosed the present invention and preferred embodiments thereof in such clear and concise terms as to enable those skilled in the art to understand and practice same, the invention claimed is:

1. A method, comprising:
detecting software installed on a first computer;
checking the software to see if the first computer is security compliant;
preventing the first computer from communicating with a second computer if it is security non-compliant; and
allowing the first computer to communicate with a third computer, the third computer making the first computer security compliant.

2. The method of claim 1, further including rebooting the first computer after it has been made security compliant.

3. The method of claim 1, wherein the first and third computers are running different operating systems.

4. The method of claim 1, further including directing the first computer to a website, the website being displayed by the third computer.

5. The method of claim 1, wherein the third computer detects software installed on the first computer.

6. The method of claim 5, wherein the first computer is made security compliant in response to a single input.

7. The method of claim 1, further allowing the first computer to communicate with the second computer after it is made security compliant.

8. A method, comprising:
providing a first computer which runs software;
detecting with a second computer the software running on the first computer to see if it needs to be updated;
allowing the first computer to communicate with a third computer if the software has been updated;
preventing the first computer from communicating with the third computer if the software has not been updated; and
updating the software on the first computer if it needs to be updated so that the first computer is security compliant.

9. The method of claim 8, wherein the software includes security software and operating system software.

10. The method of claim 8, wherein updating the software includes updating the software in response to a single input.

11. The method of claim 8, wherein software running on the second computer:
allows the first computer to communicate with the third computer if the software has been updated;
prevents the first computer from communicating with the third computer if the software is not updated; and
updates the software running on the first computer to make it security compliant.

12. The method of claim 11, further including sending a confirmation between the first and second computers in response to the software being updated.

13. The method of claim 8, wherein the second computer installs a software patch on the first computer to update the software.

14. The method of claim 8, wherein the first computer communicates with the second and third computers via a communication network.

15. A method, comprising:
detecting software installed on a plurality of computers;
checking the software installed on each computer to see if it is up to date;
allowing each computer in the plurality of computers to connect to a first communication network if its software is up to date;
allowing each computer in the plurality of computers to connect to a second communication network if its software is not up to date; and
updating the software installed on each computer if it is not up to date.

16. The method of claim 15, wherein the software is updated using the second communication network.

17. The method of claim 16, wherein the second communication network includes a security server which runs security software.

18. The method of claim 15, further including sending a confirmation between the second communication network and each computer in the plurality of computers after the software has been updated.

19. The method of claim 15, further including directing each computer in the plurality of computers to a website hosted by the second communication network if its software is not up to date.

20. The method of claim 19, wherein the updating of the software is in response to at least one input being received by the website.
